(19) United States
(12) Patent Application Publication
(10) Pub. No.: US 2013/0255428 A1
(43) Pub. Date: Oct. 3, 2013

(54) ROBOT

(71) Applicant: SEIKO EPSON CORPORATION, Tokyo (JP)

(72) Inventors: Seiji HAHAKURA, Suwa (JP); Takuya OWA, Matsumoto (JP)

(73) Assignee: Seiko Epson Corporation, Tokyo (JP)

(21) Appl. No.: 13/854,210

(22) Filed: Apr. 1, 2013

(30) Foreign Application Priority Data
Apr. 2, 2012 (JP) 2012-084352

(51) Int. Cl. B25J 18/00

(52) U.S. Cl. CPC B25J 18/00; Y10S 901/23
USPC 74/490.03; 74/490.01; 901/23

(57) ABSTRACT

A robot includes an arm. The arm includes a long-shaped arm body having a storing section configured of a concave section which is formed to open to a side surface thereof; a driving mechanism which is stored in the storing section and has a motor; and a sealing section airtightly sealing the storing section. The sealing section includes a frame body which has a frame shape along an edge of the opening section opened to the side surface of the storing section and is adhered to the edge with adhesive, and has a plurality of female screws in which a plurality of bolts are screwed, respectively; a cover which is detachably installed on the frame body by the bolts which are screwed in the female screws and covers the storing section in a installed state; and a packing interposed between the frame body and the cover.

### BACKGROUND

1. Technical Field

The present invention relates to a robot.

2. Related Art

In the related art, a robot is disclosed which includes a base stand, a plurality of arms which are displaceably supported on the base stand and are connected to each other (see, for example, JP-A-2002-239970). In the robot disclosed in JP-A-2002-239970, for example, one arm has a housing which is an arm body; a motor, a pulley, a belt, or the like which are stored in the housing and function as a driving mechanism; and a cover covering the driving mechanism. The housing has a plurality of female screws. Then, the cover is fixed to the housing by screwing each bolt in each female screw, in other words, via the bolt.

In addition, a packing and a plate supporting the packing are interposed between the housing and the cover, and those members are fixed collectively with the cover by a bolt. As described above, in the robot disclosed in JP-A-2002-239970, a so-called “tightening together” which fixes the cover and the plate with one bolt is employed. In addition, the packing is disposed to be put between two members (between the cover and the plate in the case of JP-A-2002-239970). Then, “the tightening together” is unfavorable in design and in assembling (including maintenance by disassembling).

In addition, when performing the maintenance of the driving mechanism, the maintenance is performed by loosing each bolt and removing the cover. However, in the robot disclosed in JP-A-2002-239970, when the maintenance is repeated, the female screw of the housing is damaged. In other words, threads thereof may be destroyed. In this case, the maintenance cannot be performed after detaching the cover. In addition, since the cover remains in a removed state, as a result, the driving mechanism is exposed, the maintenance is performed frequently and safety cannot be ensured. Accordingly, the robot cannot be useable.

### SUMMARY

An advantage of some aspects of the invention is to provide a robot in which maintenance of a driving mechanism can be easily performed.

An aspect of the invention is directed to a robot including: an arm body in which a storing section including an opening section that opens to an outer surface thereof is formed; a driving mechanism stored in the storing section; and a sealing section airtightly sealing the storing section. The sealing section includes a frame body which has a frame shape along an edge of the opening section, is adhered to the edge with adhesive and has a female screw in which a bolt is screwed; a cover which is detachably installed on the frame body by the bolt which is screwed in the female screw and covers the storing section in a state of being installed on the frame body; and a packing interposed between the frame body and the cover.

According to the aspect of the invention, when maintenance of the driving mechanism is performed, if each bolt which fixes the cover to the frame body is loosened, the cover can be reliably and easily removed from the frame body. Then, the driving mechanism is exposed and the maintenance of the driving mechanism can be easily performed.

According to the aspect of the invention, the frame member has the female screw in which the bolt is screwed. Then, even though the female screw is damaged, in other words, the threads of the female screw are destroyed when the maintenance is repeated, the cover is fixed to the frame member with the bolt and then the driving mechanism can be covered again by the cover, if the frame member is merely being exchanged. After that, as described above, the maintenance can be easily performed when the bolt is loosened.

In the robot according to the aspect of the invention, it is preferable that the frame body is configured such that a first protection film which is formed by passivation treatment or plating treatment is formed on the female screw and a second protection film which is formed by coating a material having liquid repellency is formed on a portion except on the female screw.

According to this configuration, for example, in a case where the robot is disposed in an environment in which sterilization gas is filled, corrosion especially by sterilization gas in the female screw can be reliably prevented by the first protection film. In addition, for example, in a case where the robot is disposed in the environment in which the sterilization gas containing the medical agent is filled, the frame body may be affected according to a type of the medical agent attached to the frame body, however, the second protection film can reliably prevent the medical agent from attaching.

In the robot according to the aspect of the invention, it is preferable that the passivation treatment is alumite treatment.

Such treatment is excellent in corrosion resistance. In addition, when forming the first protection film, the management of the thickness of the first protection film can be easily performed and then the first protection film having a desired thickness is obtained.

In the robot according to the aspect of the invention, it is preferable that the plating treatment is electroless nickel plating.

Such treatment is excellent in the corrosion resistance. In addition, when forming the first protection film, the management of the thickness of the first protection film can be easily performed and then the first protection film having a desired thickness is obtained.

In the robot according to the aspect of the invention, it is preferable that the material having liquid repellency is a fluorine-based material.

Such a material is excellent in chemical resistance. In addition, such a material also has an antifouling function and, for example, even though dust, dirt or oil is attached to the frame body, those can be easily wiped.

In the robot according to the aspect of the invention, it is preferable that the packing is in a compressed state between the frame body and the cover, and the frame body has a regulation section regulating a compression limit with respect to the packing.

According to this configuration, the packing can be compressed enough and then airtightness inside the storing section can be preferably ensured. In addition, for example, even though the packing is being exchanged a plurality of times when doing periodic maintenance, the constant compression limit of the packing can be reliably regulated each time.

In the robot according to the aspect of the invention, it is preferable that the frame body is configured such that chamfer is applied to at least a portion of the edge outside the frame body.

According to this configuration, the cover installed on the frame body can be reduced as the chamfer being applied to the frame body. Accordingly, reduction of the weight of the arm (the robot) can be achieved.

In addition, interference with the periphery of the arm is prevented as the chamfer is being applied to the frame body. Accordingly, the moving range of the arm can be ensured as wide as possible.

In the robot according to the aspect of the invention, it is preferable that the driving mechanism has a motor, a first pulley connected to the motor, a second pulley disposed being separated from the first pulley and a timing belt hanging between the first pulley and the second pulley, and the frame body does not overlap any of the motor, the first pulley, the second pulley and the timing belt in a side view of the arm body.

According to this configuration, when any of the motor, the first pulley, the second pulley and the timing belt is taken out from the storing section during maintenance, if any of them is pulled toward a worker, the taking-out can be easily performed.

In the robot according to the aspect of the invention, it is preferable that the arm body and the frame body are configured of aluminum or aluminum alloy.

According to this configuration, for example, in a case where the arm body is a casting formed using a mold, the mold forming may be easily performed by using aluminum or aluminum alloy as the configuration material of the arm body. In addition, for example, if the frame body is obtained from a metal plate that is a mother material thereof by a cutting process, the cutting process can be easily performed by using aluminum or aluminum alloy as the configuration material of the frame body.

In the robot according to the aspect of the invention, it is preferable that the cover is a flat plate configured of stainless steel.

According to this configuration, deposition of dust, dirt or the like on the cover can be prevented or suppressed compared to a case where irregularities are formed on the cover. In addition, even though dust, dirt or the like is deposited, the foreign matter can be easily wiped.

In addition, in the robot according to the aspect of the invention, it is preferable that the female screws are disposed with an interval therebetween along the circumferential direction of the frame body.

According to this configuration, the fixing force is substantially uniformly distributed by the plurality of the bolts screwed in the female screws. Accordingly, the cover can be reliably fixed. In addition, the packing can be uniformly compressed between the frame body and the cover. Accordingly, the airtightness can be reliably ensured by the packing.

In the robot according to the aspect of the invention, it is preferable that the storing section is open to the outer surface of the arm body via the center axis at both side portions.

According to this configuration, when the maintenance of the driving mechanism is performed, the maintenance may be performed from one side and also from the other side of the both sides according to the disposition position (location) of the object member of the maintenance.

In the robot according to the aspect of the invention, it is preferable that the driving mechanism has two motors and the two motors are disposed symmetrically about the center axis of the arm body as a center of symmetry.

According to this configuration, reduction of the size of the arm (the arm body) can be achieved. Accordingly, the movable range of the arm can be ensured as wide as possible. In addition, the sealing section of one side and the sealing section of the other side of the both sides can be a common configuration.

In the robot according to the aspect of the invention, it is preferable that the motor is decentered toward the base stand side with respect to the arm body.

According to this configuration, the motor is relatively heavy among the members configuring the driving mechanism. Thus, for example, when the arm is rotated around the axis which is parallel in the horizontal direction, the motor can be quickly rotated if the motor is located at the base stand side inside the arm body (the storing section).

In the robot according to the aspect of the invention, it is preferable that the wrist in which a manipulator is installed is connected to the end portion of the opposite side to the base stand in the arm and the driving mechanism is capable of driving the wrist.

According to this configuration, the posture of the manipulator can be appropriately changed according to the shape or the size of the object grasped by the manipulator which is installed in the wrist.

### BRIEF DESCRIPTION OF THE DRAWINGS

The invention will be described with reference to the accompanying drawings, wherein like numbers reference like elements.

FIG. 1 is a perspective view of a robot of an embodiment of the invention which is viewed from the front side.

FIG. 2 is a perspective view of the robot of the embodiment of the invention which is viewed from the rear side.

FIG. 3 is a schematic view of the robot of the embodiment of the invention.

FIG. 4 is a block diagram of a main portion of the robot of the embodiment of the invention.

FIG. 5 is a perspective view illustrating a use state (an installation state) of the robot of the embodiment of the invention.

FIG. 6 is an exploded perspective view of one representative arm of a plurality of arms included in the robot of the embodiment of the invention.

FIGS. 7A and 7B are cross-sectional views which are taken along a line A-A in FIG. 6.

FIG. 8 is a cross-sectional view which is taken along a line B-B in FIG. 6.

FIG. 9 is an enlarged cross-sectional view of a frame body included in the robot of the embodiment of the invention.

FIG. 10 is a cross-sectional view which is taken along a line C-C in FIG. 6.

FIG. 11 is a view (a side view) which is viewed from an arrow direction D in FIG. 6.

### DESCRIPTION OF EXEMPLARY EMBODIMENTS

Hereinafter, a robot of the invention will be described in detail, based on preferable embodiments which are illustrated in the annexed drawings.

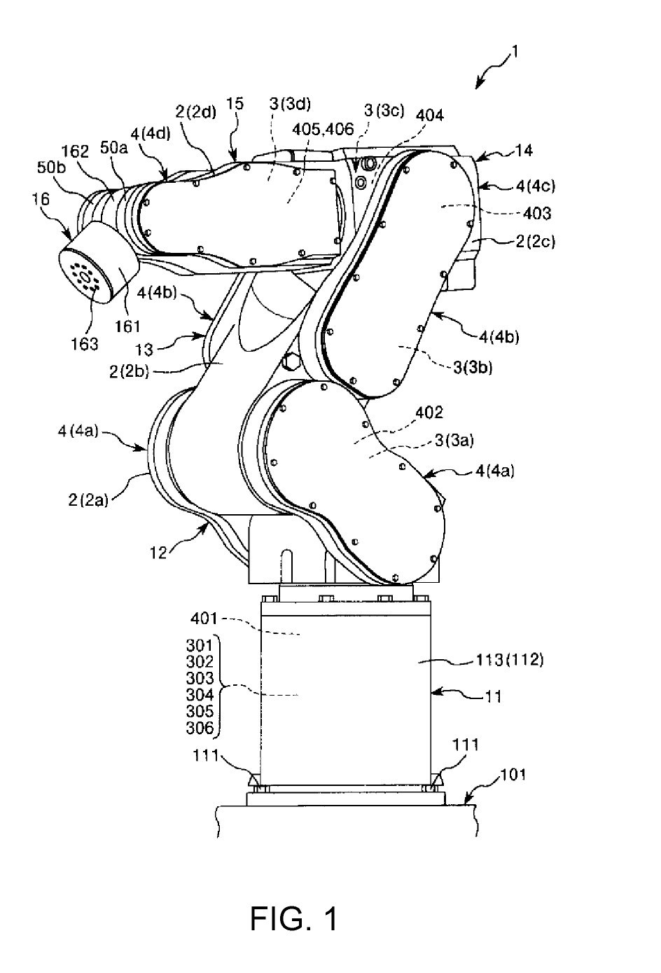

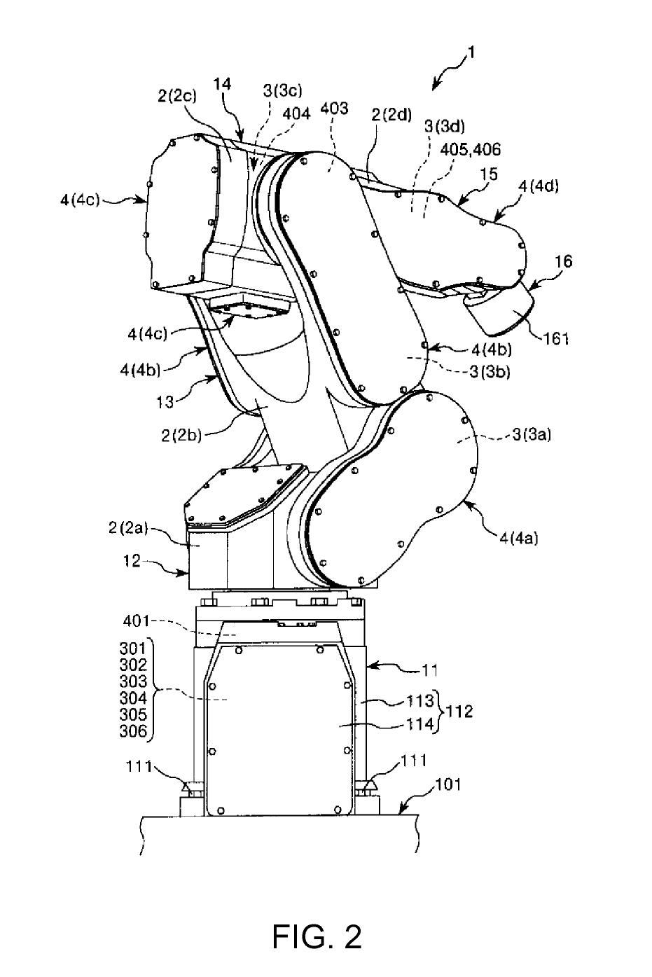

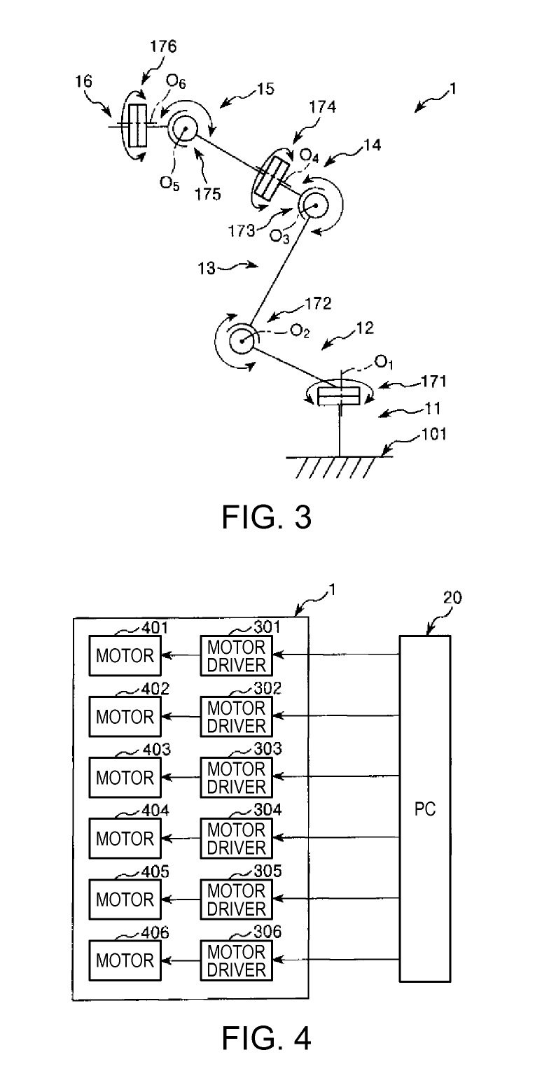

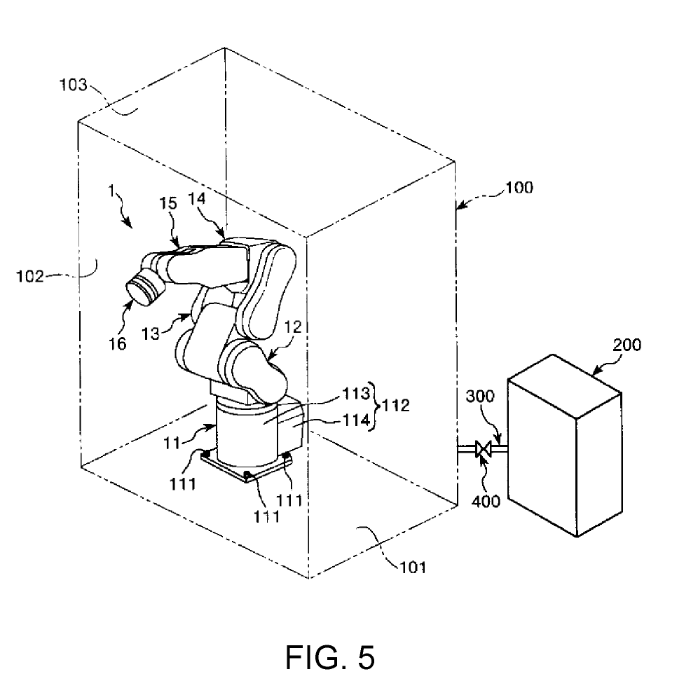

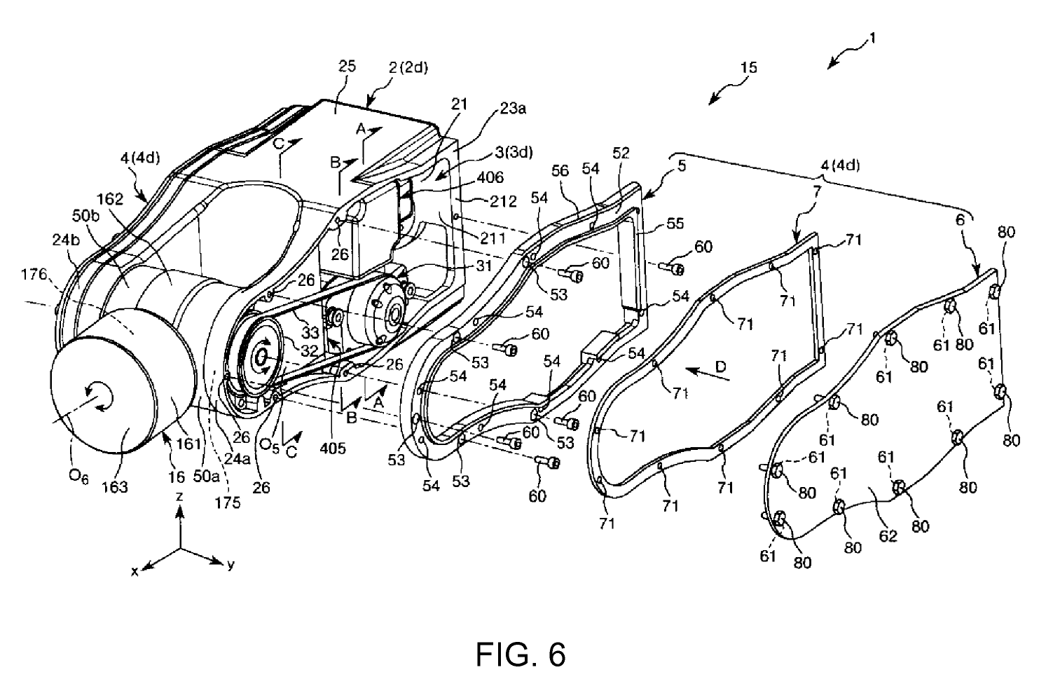

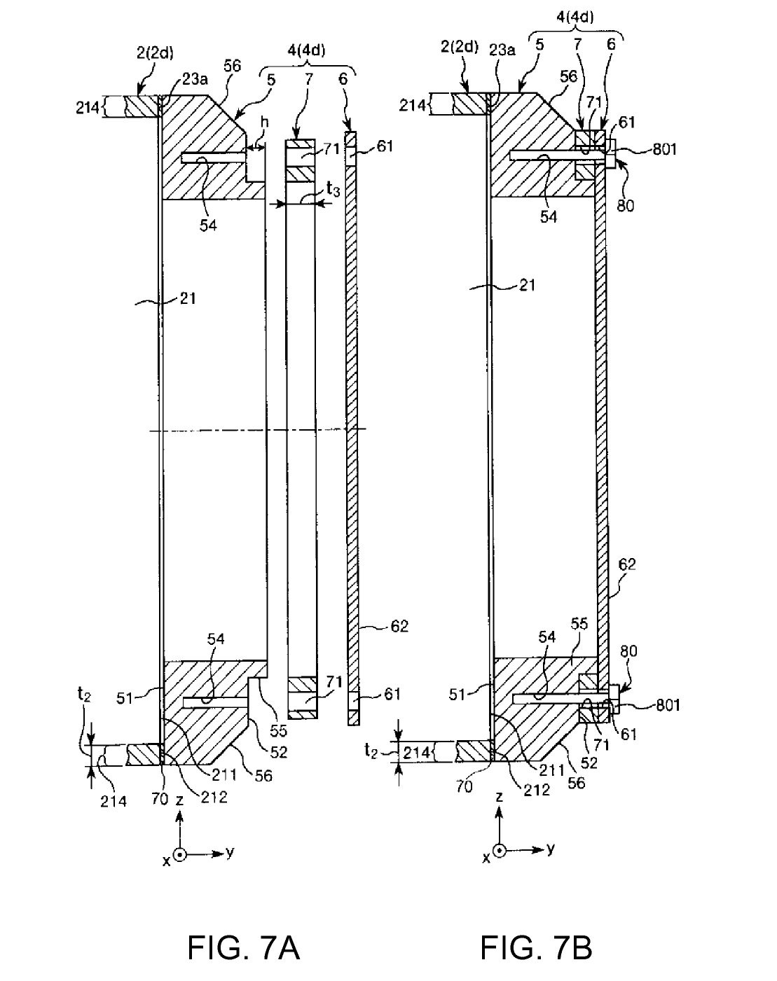

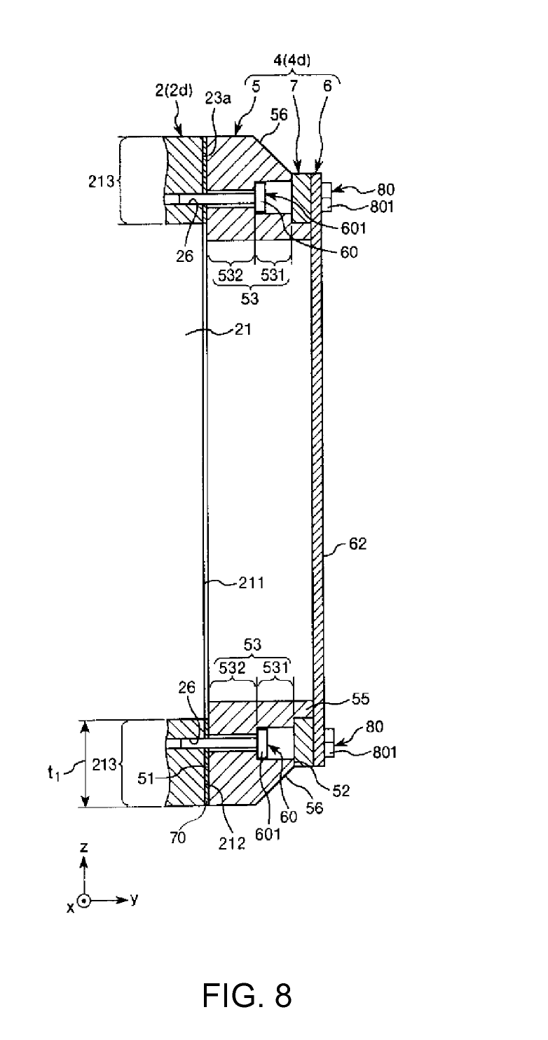

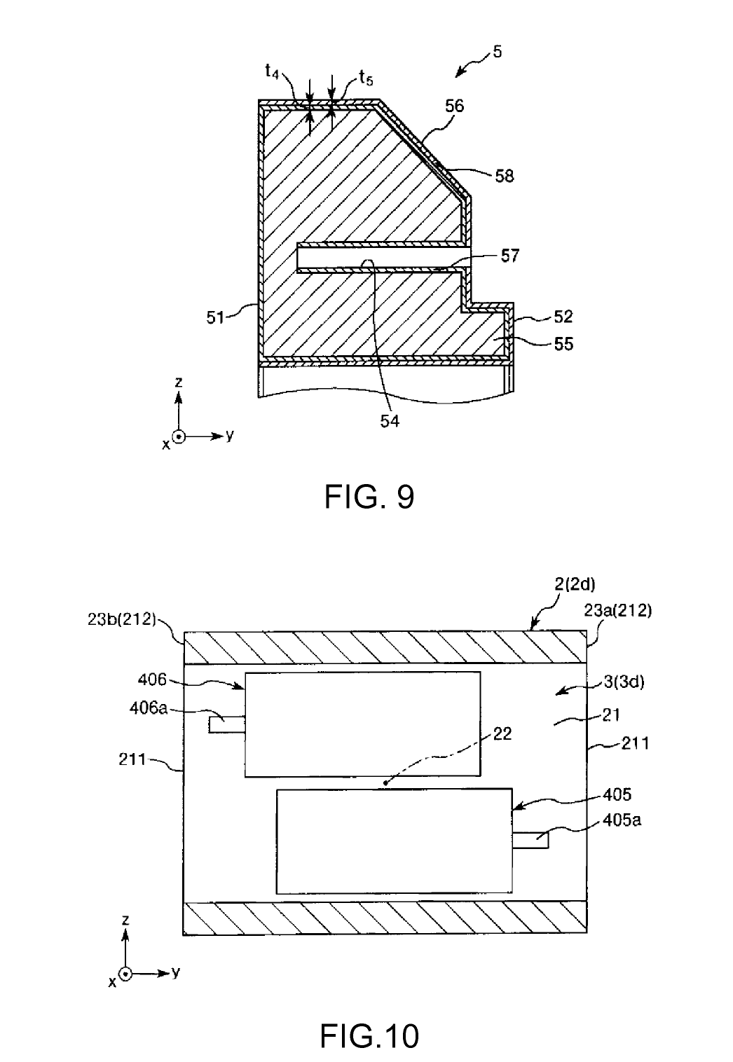

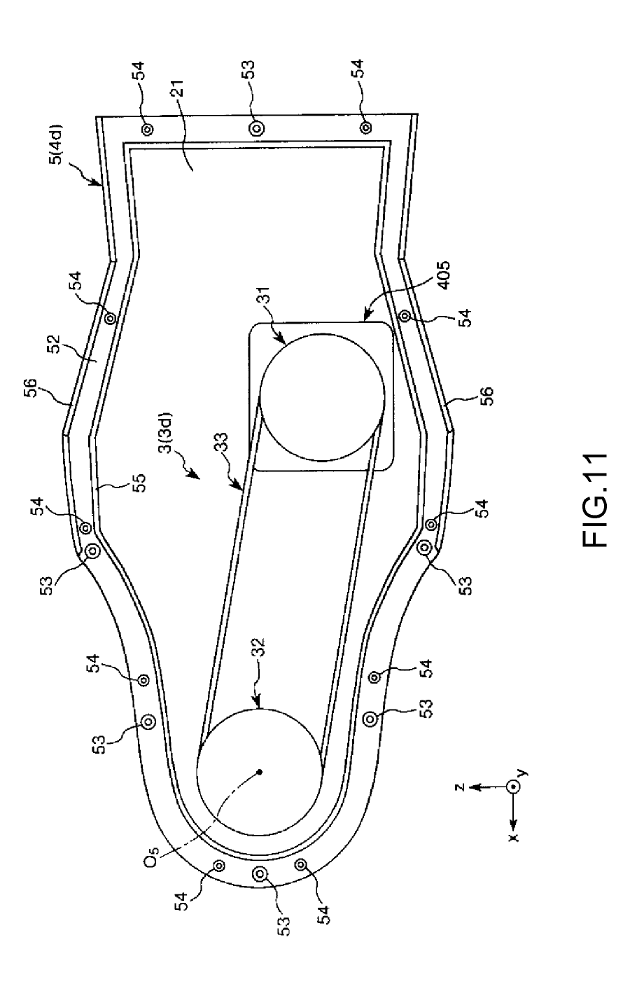

FIG. 1 is a perspective view of a robot of an embodiment of the invention which is viewed from the front side. FIG. 2 is a perspective view of the robot of the embodiment of the invention which is viewed from the rear side. FIG. 3 is a schematic view of the robot of the embodiment of the invention. FIG. 4 is a block diagram of a main portion of the robot of the embodiment of the invention. FIG. 5 is a perspective view illustrating a use state (an installation state) of the robot of the embodiment of the invention. FIG. 6 is an exploded perspective view of one representative arm of a plurality of arms included in the robot of the embodiment of the invention. FIGS. 7A and 7B are cross-sectional views which are taken along a line A-A in FIG. 6. FIG. 8 is a cross-sectional view which is taken along a line B-B in FIG. 6. FIG. 9 is an enlarged cross-sectional view of a frame body included in the robot of the embodiment of the invention. FIG. 10 is a cross-sectional view which is taken along a line C-C in FIG. 6. FIG. 11 is a view (a side view) which is viewed from an arrow direction D in FIG. 6. In addition, for the sake of convenience of the description, in FIGS. 1 to 3 and 5 to 11, upside is referred to as “up” or “above”, downside is referred to as “down” or “below”. In addition, in FIGS. 1 to 3 and 5, the base stand side is referred to as “base end” and the opposite side thereof is referred to as “front end”. In addition, in FIGS. 6 to 11, the longitudinal direction of the arm is referred to as “x-axis direction”, a direction perpendicular to the x-axis direction and the horizontal direction is referred to as “y-axis direction” and a direction perpendicular to both the x-axis direction and the y-axis direction is referred to as “z-axis direction”.

A robot (an industrial robot) 1 illustrated in FIGS. 1 to 3, for example, can be used in the inspection process to inspect precision instruments such as watches and includes a base stand 11, four arms (links) 12, 13, 14 and 15, and a wrist (link) 16. In addition, the robot 1 is a vertically articulated (six shafts) robot in which the above members are connected in the respective order. Furthermore, in the vertically articulated robot, the base stand 11, the arms 12 to 15 and the wrist 16 may be collectively referred to as “the arm”, and the base stand 11 may be referred to as “a first arm”, the arm 12 may be referred to as “a second arm”, the arm 13 may be referred to as “a third arm”, the arm 14 may be referred to as “a fourth arm”, the arm 15 may be referred to as “a fifth arm” and the wrist 16 may be referred to as “a sixth arm”, respectively.

As illustrated in FIG. 3, each of the arms 12 to 15 and the wrist 16 is displaceably supported on the base stand 11 independently.

The base stand 11 and the arm 12 are connected via an articulation (a joint) 171. Then, the arm 12 is able to rotate around a rotation axis O₁ in parallel with the vertical direction with respect to the base stand 11. The rotation around the rotation axis O₁ is carried out by driving of a motor 401. In addition, the driving of the motor 401 is controlled by a motor driver 301 which is electrically connected to the motor 401 via a cable (not illustrated) (see, FIG. 4).

The arm 12 and the arm 13 are connected via an articulation (a joint) 172. Then, the arm 13 is able to rotate around a rotation axis O₂ in parallel with the horizontal direction with respect to the arm 12 (the base stand 11). The rotation around the rotation axis O₂ is carried out by driving of a motor 402. In addition, the driving of the motor 402 is controlled by a motor driver 302 which is electrically connected to the motor 402 via a cable (not illustrated) (see, FIG. 4).

The arm 13 and the arm 14 are connected via an articulation (a joint) 173. Then, the arm 14 is able to rotate around a rotation axis O₃ in parallel with the horizontal direction with respect to the arm 13 (the base stand 11). The rotation around the rotation axis O₃ is carried out by driving of a motor 403. In addition, the driving of the motor 403 is controlled by a motor driver 303 which is electrically connected to the motor 403 via a cable (not illustrated) (see, FIG. 4).

The arm 14 and the arm 15 are connected via an articulation (a joint) 174. Then, arm 15 is able to rotate around a rotation axis O₄ in parallel with a central axis direction of the arm 14 with respect to the arm 14 (the base stand 11). The rotation around the rotation axis O₄ is carried out by driving of a motor 404. In addition, the driving of the motor 404 is controlled by a motor driver 304 which is electrically connected to the motor 404 via a cable (not illustrated) (see, FIG. 4).

The arm 15 and the wrist 16 are connected via an articulation (a joint) 175. Then, the wrist 16 is able to rotate around a rotation axis O₅ in parallel with the horizontal direction (the y-axis direction) with respect to the arm 15 (the base stand 11). The rotation around the rotation axis O₅ is carried out by driving of a motor 405. In addition, the driving of the motor 405 is controlled by a motor driver 305 which is electrically connected to the motor 405 via a cable (not illustrated) (see, FIG. 4). In addition, the wrist 16 is also able to rotate around a rotation axis O₆ perpendicular to the rotation axis O₅ via an articulation (a joint) 176. The rotation around the rotation axis O₆ is carried out by driving of a motor 406. In addition, the driving of the motor 406 is controlled by a motor driver 306 which is electrically connected to the motor 406 via a cable (not illustrated) (see, FIG. 4).

The motors 401 to 406 are not particularly limited, however, for example, preferable to use a servo motor. In addition, each of the cables described above passes through the robot 1, respectively.

As illustrated in FIG. 4, the robot 1 is electrically connected to a personal computer (PC) 20 in which the Central Processing Unit (CPU) is built as a control unit. Then, the personal computer 20 may actuate each of the arms 12 to 15 and the wrist 16, independently. In other words, the personal computer 20 may control the motors 401 to 406 via the motor drivers 301 to 306, independently. The control program thereof is stored beforehand in a recording medium built in the personal computer 20.

As illustrated in FIG. 5, in the embodiment, the robot 1 is provided inside an airtight chamber (an isolator) 100. The chamber 100 communicates with a sterilization gas generator 200 generating a sterilization gas (for example, hydrogen peroxide vapor) via a pipe 300. Then, the robot 1 is subjected to sterilization by the sterilization gas from the sterilization gas generator 200, before the start of work or after completion of the work. In addition, the pipe 300 has a valve 400 in the middle of the longitudinal direction thereof. The valve 400 is intended to switch between a communication state in which the chamber 100 communicates with the sterilization gas generator 200 and a blocking state to block the communication state.

As described above, the robot 1 includes the base stand 11, the arms 12 to 15 and the wrist 16.

As illustrated in FIGS. 1 and 2, the base stand 11 is positioned lowermost of the vertically articulated robot and is a portion fixed to a floor 101 of the chamber 100 when the robot 1 is the vertically articulated robot. The fixing method is not particularly limited, however, for example, in the embodiment illustrated in FIGS. 1 and 2, a plurality of bolts 111 is used in the fixing method. In addition, the fixing locations of the base stand 11 in the chamber 100 may be a wall 102 or a ceiling 103 of chamber 100 other than the floor 101.

The base stand 11 has a hollow base stand body (a housing) 112. The base stand body 112 may be divided into a cylindrical section 113 having a cylindrical shape and a box-shaped section 114 having a box shape which is formed integrally on the outer periphery of the cylindrical section 113. Then, in such a base stand body 112, for example, the motor 401 or the motor drivers 301 to 306 are stored.

The arms 12 to 15 have a hollow arm body 2, a driving mechanism 3 and a sealing unit 4, respectively, and have substantially the same configuration except that installation locations with respect to the base stand 11, in other words, the installation locations in the entire robot 1 and, besides that, outer shapes thereof are different from each other. In addition, for the sake of convenience of the description below, the arm body 2, the driving mechanism 3 and the sealing unit 4 included in the arm 12 are referred to as “arm body 2a”, “driving mechanism 3a” and “sealing unit 4a”, respectively, and the arm body 2, the driving mechanism 3 and the sealing unit 4 included in the arm 13 are referred to as “arm body 2b”, “driving mechanism 3b” and “sealing unit 4b”, respectively, and the arm body 2, the driving mechanism 3 and the sealing unit 4 included in the arm 14 are referred to as “arm body 2c”, “driving mechanism 3c” and “sealing unit 4c”, respectively, and the arm body 2, the driving mechanism 3 and the sealing unit 4 included in the arm 15 are referred to as “arm body 2d”, “driving mechanism 3d” and “sealing unit 4d”, respectively.

The arm 12 is connected to an upstream end portion (a front end portion) of the base stand 11 in an inclined posture in the horizontal direction. In the arm 12, the driving mechanism 3a has the motor 402 and is stored inside the arm body 2a. In addition, the inside of the arm body 2a is airtightly sealed by the sealing unit 4a.

The arm 13 is connected to a front end portion of the arm 12. In the arm 13, the driving mechanism 3b has the motor 403 and is stored inside the arm body 2b. In addition, the inside of the arm body 2a is airtigtly sealed by the sealing unit 4b.

The arm 14 is connected to a front end portion of the arm 13. In the arm 14, the driving mechanism 3c has the motor 404 and is stored inside the arm body 2c. In addition, the inside of the arm body 2c is airtightly sealed by the sealing unit 4c.

The arm 15 is connected to a front end portion of the arm 14 in parallel with the central axis direction thereof . In the arm 15, the driving mechanism 3d has the motors 405 and 406 and is stored inside the arm body 2d. In addition, the inside of the arm body 2d is airtightly sealed by the sealing unit 4d.

The wrist 16 is connected to a front end portion (an end portion opposite side of the base stand 11) of the arm 15. A manipulator (not illustrated) holding the precision instruments such as watches is detachably installed on the front end portion thereof in the wrist 16. In addition, the manipulator is not particularly limited, however, for example, may be a manipulator which has a configuration having a plurality of fingers. Then, the robot 1 may transport the precision instruments by controlling the operation of the arms 12 to 15, the wrist 16, or the like while holding the precision instruments with the manipulator.

As illustrated in FIG. 6, the wrist 16 has a wrist body 161 having a cylindrical shape and a support ring 162 having a ring shape, which is configured of a separate body with the wrist body 161 and is provided in the base end portion of the wrist body 161.

The front end surface 163 of the wrist body 161 is a flat surface and is an installation surface on which the manipulator is installed. In addition, the wrist body 161 is connected to the driving mechanism 3d of the arm. 15 and rotates around the rotation axis O₆ by the driving of the motor 406 of the driving mechanism 3d.

The support ring 162 is connected to the driving mechanism 3d of the arm. 15 and rotates around the rotation axis O₅ by the driving of the motor 405 of the driving mechanism 3d together with the wrist body 161.

Next, the arms 12 to 15 are described in detail. Since the arms 12 to 15 are substantially the same configuration as each other except that the installation locations of the entire robot 1 and the outer shapes thereof as described above are different, the typical arm 15 is described below.

As illustrated in FIG. 6, the arm 15 has the arm body 2 (2d), the driving mechanism 3 (3d), the sealing unit 4 (4d).

The arm body 2 is configured of an elongated body along the x-axis direction and the elongated body is configured of a pair of tongue sections 24a and 24b in the front end side, and a base section 25 in the base end side. The tongue section 24a and the tongue section 24b are separated in the y-axis direction. Then, the support ring 162 of the wrist 16 is disposed between the tongue section 24a and the tongue section 24b. Furthermore, the cylindrical part 50a is interposed between the tongue section 24a and the support ring 162, and the cylindrical part 50b is interposed between the tongue section 24b and the support ring 162. Accordingly, the wrist 16 is held on the arm 15.

In addition, the arm body 2 has a storage section 21 storing the driving mechanism 3. The storage section 21 is configured of a concave section which is open to two side surfaces 23a and 23b (outer surface) disposed via a center axis 22 of the arm body 2 (see, FIG. 10). Accordingly, when maintenance with respect to the driving mechanism 3 is performed, the maintenance may be performed from the side surface 23a side and performed from the side surface 23b side. For example, when exchanging the motor 405, the exchange may be easily performed from the side surface 23a side and when exchanging the motor 406, the exchange may be easily performed from the side surface 23b side. As described above, the robot 1 has excellent maintenance.

The configuration material of the arm body 2 is not particularly limited, however, for example, various metal materials may be used and, among them, it is preferable to use aluminum or aluminum alloy, particularly. When the arm body 2 is a casting formed using a mold, the mold forming may be easily performed by using aluminum or aluminum alloy on the configuration material of the arm body 2.

In addition, the configuration material of the above described base stand body 112 of the base stand 11, or the configuration material of the support ring 162 of the wrist 16 may use the same configuration materials of the arm body 2. In addition, the configuration material of the wrist body 161 of the wrist 16 is preferable to use stainless steel.

As illustrated in FIGS. 6 and 10, the driving mechanism 3 has the motors 405 and 406. Both the motors 405 and 406 are decentered toward the base section 25 side inside the storage section 21, that is, located on the base stand 11 side with respect to the arm body 2. The motors 405 and 406 are relatively heavy. Thus, when the arm 14 is rotated around the rotation axis O₃ together with the arm 15, the rotation may be carried out quickly if the motors 405 and 406 are located on the base section 25 side inside the arm 15 (the storage section 21).

The motor 405 has a rod shape and has a shaft (a shaft member) 405a rotatably supported around the axle thereof, and the shaft 405a protrudes toward the side surface 23a side (see, FIG. 10). The motor 406 has a rod shape and has a shaft (a shaft member) 406a on which the motor 406 is rotatably supported around the shaft thereof, and the shaft 406a protrudes toward the side surface 23a side (see, FIG. 10).

In addition, the driving mechanism 3 further has a first pulley 31 connected to the shaft 405a of the motor 405, a second pulley 32 which is separated from the first pulley 31 and is disposed in the tongue section 24a and a belt (a timing belt) 33 which is hung between the first pulley 31 and the second pulley 32. The first pulley 31, the second pulley 32 and the belt 33 are positioned on the side surface 23a side similar to the shaft 405a of the motor 405 and transmit the rotational force of the shaft 405a to the wrist 16 and then the wrist 16 can be reliably rotated around the rotation axis O₅ (the second pulley 32).

In addition, the driving mechanism 3 also has the first pulley 31 connected to the shaft 406a of the motor 406, the second pulley 32 which is separated from the first pulley 31 and is disposed in the tongue section 24b and the belt 33 which is hung between the first pulley 31 and the second pulley 32 in the side surface 23b side. The first pulley 31, the second pulley 32 and the belt 33 in the side surface 23b side transmit the rotational force of the shaft 406a of the motor 406 to the wrist 16 and then the wrist 16 can be reliably rotated around the rotation axis O₆.

As illustrated in FIG. 10, the motor 405 and the motor 406 are disposed symmetrically (point symmetry) about the center axis 22 of the arm body 2 as a center of symmetry (a point of symmetry). Furthermore, the first pulley 31, the second pulley 32 and the belt 33 which are sequentially connected to the motor 405 in the side surface 23a side, and the first pulley 31, the second pulley 32 and the belt 33 which are sequentially connected to the motor 406 in the side surface 23b side are disposed symmetrically about the center axis 22 as the center of symmetry (point symmetry).

Such a symmetric disposition contributes to the reduction of the size of the arm 15 (the arm body 2) and movable range of the arm 15 can be ensured as wide as possible. In addition, as described below, the sealing unit 4 (4d) of the side surface 23a side and the sealing unit 4 (4d) of the side surface 23b side may be a common configuration.

Next, the sealing unit 4 (4d) is described. In the arm 15, the sealing unit 4 is provided in the side surface 23a side and the side surface 23b side, respectively. Since the sealing unit 4 in the side surface 23a side and the sealing unit 4 in the side surface 23b side are the same configuration as each other, the sealing unit 4 in the side surface 23a side is typically described.

The sealing unit 4 airtightly seals the storage section 21. Waterproof function and dustproof function are exhibited to the driving mechanism 3 (3d) inside the storage section 21 by the sealing unit 4. In addition, the sterilization gas from the sterilization gas generator 200 may corrode the driving mechanism 3, however, the corrosion can be reliably prevented by the sealing unit 4.

As illustrated in FIGS. 6, 7A, 7B and 8, the sealing unit 4 has a frame body 5, a packing 7 and a cover 6, and those are overlapped in the order from the arm body 2 side.

As illustrated in FIG. 6, the frame body 5 is a member having a frame shape along an edge 212 of an opening section 211 which is open to the side surface 23a (the outer surface) of the storage section 21 of the arm body 2. A thickness of the member is, for example, may be approximately 10 mm.

As illustrated in FIGS. 7A, 7B and 8, the frame body 5 has a rear surface 51 which is joined to the edge 212 via an adhesive layer (adhesive) 70. The adhesive layer 70 is formed along the edge 212. Accordingly, an interval between the rear surface 51 of the frame body 5 and the edge 212 of the arm body 2 is prevented from occurring, and the airtightness inside the storage section 21 can be ensured. As described above, the adhesive layer 70 also functions as “a gasket (packing)” filling between the rear surface 51 of the frame body 5 and the edge 212 of the arm body 2.

In the robot 1, the adhesive layer 70 is responsible for fixing the arm body 2 to the frame body 5. Furthermore, in the robot 1, a plurality (for example, six) of bolts 60 are responsible for ancillary fixing to the arm body 2 of the frame body 5 (see, FIGS. 6 and 8). Accordingly, the arm body 2 and the frame body 5 are fixed more firmly. In addition, the arm body 2 maybe fixed to the frame body 5 by the bolt 60 temporally until the adhesive layer 70 is cured.

In the frame body 5, an insertion hole 53 into which each bolt 60 is inserted is formed to pass through from a front surface 52 to the rear surface 51. As illustrated in FIGS. 6 and 11, each insertion hole 53 is disposed having an interval along the circumferential direction of the frame body 5. In addition, as illustrated in FIG. 8, each insertion hole 53 has “counterbore” and is configured of two portions of which inner diameters are different from each other, that is, is configured of a large diameter section 531 having a large inner diameter in the front surface 52 side and a small diameter section 532 having a small inner diameter in the rear surface 51. Accordingly, a head section 601 of each bolt 60 is prevented from protruding from the front surface 52 of the frame body 5 and then the head section 601 can be reliably prevented from inhibiting the disposition of the packing 7 as described below.

Meanwhile, a female screw 26 is formed at a portion corresponding to each insertion hole 53 of the edge 212 of the arm body 2. Then, the bolt 60 inserted into each insertion hole 53 of the frame body 5 can be screwed in each female screw 26. Accordingly, the ancillary fixing described above is accomplished.

In addition, as illustrated in FIGS. 7A, 7B and 8, in the edge 212 of the arm body 2, a portion in which the female screw 26 is formed and the other portion have different thicknesses. A thickness t₁ of the former (hereinafter, referred to as “thick section 213”) is thicker than a thickness t₂ of the latter (hereinafter, referred to as “thin section 214”) for the female screw 26 being formed. However, since the formation region of the thin section 214 is wider than that of the thick section 213, reduction in the weight of the arm body 2 can be achieved.

The bolt 60 is not particularly limited, however, for example, it is preferable to use a so-called “hexagon socket head cap screw” of which fastening and unfastening are performed using a hexagon wrench.

As illustrated in FIGS. 6 and 11, in the front surface 52 of the frame body 5, a plurality (for example, ten in the illustrated configuration) of female screws 54 are formed in which a plurality (for example, ten in the illustrated configuration) of bolts 80 are screwed for fixing the cover 6 with respect to the frame body 5. Each female screw 54 is disposed along the circumferential direction of the frame body 5 having an interval. Accordingly, a fixing force by the bolts 80 is substantially uniformly distributed and then the cover 6 can be reliably fixed. In addition, the packing 7 can be uniformly compressed between the cover 6 and the frame body 5. Accordingly, the airtightness can be reliably ensured by the packing 7 (see, FIGS. 7B and 8).

In addition, as illustrated in FIGS. 7A and 7B, each female screw 54 is preferable to form until the middle of the frame body 5 in the thickness direction, that is, is preferable not to reach the rear surface 51.

In addition, the packing 7 is provided (placed) on the front surface 52 of the frame body 5. Accordingly, the front surface 52 also functions as a packing installation section on which the packing 7 is provided.

Then, the packing 7 provided on the front surface 52 is compressed by the cover 6. At this time, in the frame body 5, it is possible to regulate the compression limit for the packing 7 by a regulation section 55. Accordingly, the packing 7 can be compressed without any excess or deficiency. Thus, the airtightness inside the storage section 21 can be suitably secured. In addition, for example, when the packing 7 is being exchanged multiple times during regular maintenance, it is possible to reliably regulate a constant compression limit for the packing 7, each time. As described above, the robot 1 has excellent maintenance.

Such a regulation section 55 protrudes toward the front surface 52 and configured of a rib formed along the circumferential direction of the frame body 5. A height h of the regulation section 55 is not particularly limited, however, for example, is preferable to compress a thickness t₃ to 10% to 40%, and is further preferable to compress to 20% to 30% when the thickness of the packing 7 is t₃ in the natural state that does not grant an external force (see, FIGS. 7A and 7B). For example, if the height h is 1.5 mm, the packing 7 can be compressed to 0.5 mm (25%) when the thickness t₃ is 2 mm.

In the frame body 5, a chamfered section 56, which is made by chamfering, is formed in a portion (at least a part) of the base end side of the outside edge thereof. Accordingly, the cover 6 installed on the frame body 5 can be small for the chamfered section 56. Thus, reduction in the weight in the arm 15 (the robot 1) can be accomplished. In addition, interference of the arm 15 with the periphery is prevented for the chamfered section 56 and then the movable range of the arm 15 can be ensured as wide as possible.

As illustrated in FIG. 11, the frame body 5 does not overlap any of the motor 405, the first pulley 31, the second pulley 32 and the belt 33 in a side view of the arm body 2. Accordingly, when any of the motor 405, the first pulley 31, the second pulley 32 and the belt 33 is taken out from the storing section 21 during maintenance, the take-out work can be easily performed if any of them is pulled out in the front side (the direction opposite to the arrow D in FIG. 6) of the paper surface in FIG. 11. As described above, the robot 1 has excellent maintenance.

The configuration material of the frame body 5 is not particularly limited, however, for example, various types of metal materials can be used, and among them, it is preferable to use is aluminum or aluminum alloy. When the frame body 5 is obtained from a metal plate that is a mother material thereof by a cutting process, the cutting process can be easily performed if the aluminum or aluminum alloy is used as the configuration material of the frame body 5. In addition, passivation treatment or plating treatment can be easily and reliably performed on the frame body 5. Accordingly, a first protection film 57 described below can be reliably formed.

When the frame body 5 having the same configuration as the above description is integrally formed with the arm body 2, the size of the arm body 2 that is a casting is increased greater than the size of the frame body 5. As a result, the weight of the arm body 2 is also increased and the operating speed of the arm body 2 is decreased. However, in the robot 1, since the arm body 2 is configured of a separated body from the frame body 5, such a problem can be prevented from occurring. In addition, the sealing unit 4 having the frame body 5 can be easily added on the existing robot of the related art.

In addition, for example, even though the female screw 54 of the frame body 5 is damaged, that is, a thread of the female screw 54 is destroyed by repeating the maintenance, if only the frame body 5 is being exchanged, the cover 6 can be reliably installed in the exchanged frame body 5. Accordingly, the robot 1 can be safely used.

As illustrated in FIG. 9, a first protection film 57 and a second protection film 58 are formed in the frame body 5.

The first protection film 57 is formed at least in each female screw 54 (the entire surface of the frame body 5 in the embodiment) of the frame body 5. The first protection film 57 is a film to be subjected to the passivation treatment or plating treatment on the frame body 5. As described above, although the sterilization gas may corrode the driving mechanism 3, it is possible to reliably prevent the corrosion, particularly in each female screw 54 by the first protection film 57.

In addition, as the passivation treatment, alumite treatment is preferable and as the plating treatment, electroless nickel plating is preferable. Such treatments are excellent in the corrosion resistance. In addition, when the first protection film 57 is formed, management of a thickness t₄ of the first protection film 57 can be easily performed. Accordingly, the first protection film 57 having a desired thickness is obtained.

The thickness t₄ of the first protection film 57 is not particularly limited, however, for example, is preferable to be 10 to 100 μm and is further preferable to be 30 to 80 μm.

The second protection film 58 is formed on a portion (a portion other than the rear surface 51 and each female screw 54 of the frame body 5 in the embodiment) except each female screw 54 of the frame body 5 to be overlapped on the first protection film 57. The second protection film 58 is a film formed by applying a material having liquid repellency. For example, if a medical agent is contained in the sterilization gas, the medical agent attaches to the frame body 5 and may affect the frame body 5 according to the type of the medical agent. However, the attachment of the medical agent can be reliably prevented by the second protection film 58.

In addition, the material having the liquid repellency that is preferable to use is a fluorine-based material. Such a material has excellent chemical resistance. In addition, even though the medical agent attaches to the frame body 5, the medical agent can be easily wiped. In addition, the second protection film 58 has an antifouling function and, for example, even though dust, dirt or oil attaches to the frame body 5, the foreign matter can be easily wiped.

The thickness t₅ of the second protection film 58 is not particularly limited, however, for example, is preferable to be 10 to 50 μm and is further preferable to be 20 to 40 μm. A contact angle of the second protection film 58 with water is not particularly limited, however, for example, is preferable to be 100 to 150 degrees and is further preferable to be 100 to 120 degrees.

In the frame body 5, the cover 6 having a planar plate shape is detachably installed. The storage section 21 can be covered with the installed state cover 6. Accordingly, the driving mechanism 3 can be protected and it is possible to reliably prevent that a hand or the like accidentally touches the driving mechanism 3 during operation.

In the cover 6, through holes 61 in which the bolts 80 pass through are formed at positions corresponding to each female screw 54 of the frame body 5, respectively. Each through hole 61 is formed as a through hole passing through the cover 6 in the thickness direction. Then, in each female screw 54 of the frame body 5, the bolt 80 inserted into each through hole 61 of the cover 6 can be screwed. Accordingly, the cover 6 is installed on the frame body 5, that is, becomes the installation state. In addition, in the installation state, as described above, since the packing 7 is in the compressed state, the airtightness inside the storage section 21 of the arm body 2 is reliably held.

In addition, the cover 6 can be removed from the frame body 5 by loosening the bolts 80 from the installation state. In a state where the cover 6 is removed, a worker who performs the maintenance of the driving mechanism 3 can easily perform, for example, the maintenance such as exchange of the motor 405 by inserting a finger or the like into the storage section 21 of the arm body 2 via the frame body 5.

After the maintenance is performed, when the cover 6 is installed again with the bolts 80, the packing 7 is in the compressed state. Accordingly, the airtightness inside the storage section 21 of the arm body 2 can be reliably held again. In the robot 1 described above, the airtightness inside the storage section 21 can be reliably held regardless of before or after the maintenance.

The cover 6 is configured of a planar plate (for example, the thickness thereof is substantially 2 mm) made of a completely flat metal. The metal material is not particularly limited, however, for example, is preferable to use stainless steel. Accordingly, deposition of dust, dirt or the like on the front surface 62 can be prevented or suppressed compared to a case where irregularities are formed on the front surface 62 of the cover 6. In addition, even though dust, dirt or the like is deposited, the foreign matter can be easily wiped.

In addition, the bolt 80 is not particularly limited, however, for example, a so-called “hexagon bolt” of which fastening and unfastening are performed using a spanner or a so-called “hexagon socket head cap screw” of which fastening and unfastening are performed using a hexagon wrench may be used, and, among them, “the hexagon bolt” is preferable. In “the hexagon bolt”, since there are no irregularities in the head section 801 of the bolt 80 compared to “the hexagon socket head cap screw”, deposition of dust, dirt or the like can be prevented or suppressed. In addition, even though dust, dirt or the like is deposited, the foreign matter can be easily wiped.

The compressed packing 7 is interposed between the frame body 5 and the cover 6. The packing 7 is a member having a frame shape similar to the frame body 5. The thickness of the member, for example, can be substantially 2 mm.

In addition, in the packing 7, the through holes 71 in which the bolts 80 pass through are formed at positions corresponding to each female screw 54 of the frame body 5, respectively. Each through hole 71 is configured of a through hole which passes through the packing 7 in the thickness direction. Then, each bolt 80 is screwed in the female screw 54 of the frame body 5 in a state of being passed through the through hole 71 (see, FIG. 7B). Accordingly, the packing 7 is positioned.

The configuration material of the packing 7 is not particularly limited, for example, various types of rubber materials (especially, vulcanized treated rubber) such as styrene butadiene rubber, nitrile rubber, chloroprene rubber, butyle rubber, acrylic rubber, ethylene propylene rubber, urethane rubber, silicone rubber and fluorine rubber, and various types of thermoplastic elastomers such as styrene-based, polyvinyl chloride-based, polyurethane-based, polyester-based, polyamide-based, polybutadiene-based, fluorine rubber-based, chlorinated polyethylene-based or the like may be used, and a mixture of one or more of those may be used.

The embodiment of the robot of the invention illustrated in the drawings is described, however, the invention is not limited to the embodiment. Each of the parts configuring the robot can be replaced with that of any configuration capable of exhibiting the same functions. In addition, any configuration matter may be added.

In addition, the robot of the invention has a plurality of the arms in the embodiment described above, however, the invention is not limited to the embodiment, and for example, may have one.

In addition, the driving mechanism further may include a decelerator.

The entire disclosure of Japanese Patent Application No. 2012-084352, filed Apr. 2, 2012 is expressly incorporated by reference herein.

What is claimed is:

1. A robot comprising:
an arm body in which a storing section including an opening section that opens to an outer surface thereof is formed;
a driving mechanism stored in the storing section; and
a sealing section airtightly sealing the storing section,
wherein the sealing section includes:
a frame body which has a frame shape along an edge of the opening section, is adhered to the edge with adhesive and has a female screw in which a bolt is screwed;
a cover which is detachably installed on the frame body by the bolt which is screwed in the female screw and covers the storing section in a state of being installed on the frame body; and
a packing interposed between the frame body and the cover.

2. The robot according to claim 1,
wherein the frame body is configured such that a first protection film which is formed by passivation treatment or plating treatment is formed on the female screw and a second protection film which is formed by coating a material having liquid repellency is formed on a portion except the female screw.

3. The robot according to claim 2,
wherein the passivation treatment is alumite treatment.

4. The robot according to claim 2,
wherein the plating treatment is electroless nickel plating.

5. The robot according to claim 2,
wherein the material having liquid repellency is a fluorine-based material.

6. The robot according to claim 1,
wherein the packing is in a compressed state between the frame body and the cover, and
wherein the frame body has a regulation section regulating a compression limit with respect to the packing.

7. The robot according to claim 1,
wherein the frame body is configured such that chamfer is applied to at least a portion of the edge outside the frame body.

8. The robot according to claim 1,
wherein the driving mechanism has a motor, a first pulley connected to the motor, a second pulley disposed being separated from the first pulley and a timing belt hanging between the first pulley and the second pulley, and
wherein the frame body does not overlap any of the motor, the first pulley, the second pulley and the timing belt in a side view of the arm body.

9. The robot according to claim 1,
wherein the arm body and the frame body are configured of aluminum or aluminum alloy.

10. The robot according to claim 1,
wherein the cover is a flat plate configured of stainless steel.

11. A robot comprising:
an arm body having an opening section that opens to an outer surface;
a frame body which is adhered to an edge of the opening section;
a packing abutting the frame body; and
a cover which abuts the packing, is fixed to the frame body by a fixing member and covers the opening section,
wherein the opening section is sealed by the frame body, the packing and the cover.

12. The robot according to claim 11,
wherein the fixing member is a bolt, and
wherein the frame body has a female screw in which the bolt is screwed.

13. The robot according to claim 12,
wherein the frame body is configured such that a first protection film which is formed by passivation treatment is formed on the female screw and a second protection film which is formed by coating a material having liquid repellency is formed on a portion except the female screw.

14. The robot according to claim 12,
wherein the frame body is configured such that a first protection film which is formed by plating treatment is formed on the female screw and a second protection film which is formed by coating a material having liquid repellency is formed on a portion except the female screw.

15. The robot according to claim 11,
wherein the packing is in a compressed state between the frame body and the cover, and
wherein the frame body has a regulation section regulating a compression limit with respect to the packing.
